(19) United States
(12) Patent Application Publication
(10) Pub. No.: US 2026/0258534 A1
(43) Pub. Date: Sep. 3, 2026

(54) A BAINITE SEAMLESS STEEL PIPE AND MANUFACTURING METHOD THEREFOR

(71) Applicant: Baoshan Iron & Steel Co., Ltd., Shanghai (CN)

(72) Inventors: Wen Sun, Shanghai (CN); Zhan Gao, Shanghai (CN); Guoli Zhai, Shanghai (CN); Suzhen Luo, Shanghai (CN); Ping Hu, Shanghai (CN)

(21) Appl. No.: 18/846,982

(22) PCT Filed: Mar. 17, 2023
(86) PCT No.: PCT/CN2023/082152

§ 371 Date: Sep. 13, 2024

(30) Foreign Application Priority Data
Mar. 29, 2022 (CN) 202210322387.7

(51) Int. Cl. C22C 38/38; B22D 11/00; C21C 5/56; C21D 1/18; C21D 1/84; C21D 6/00; C21D 8/10; C21D 9/08; C22C 38/00; C22C 38/02; C22C 38/04; C22C 38/06; C22C 38/32

(52) U.S. Cl. CPC C22C 38/38; B22D 11/001; C21C 5/562; C21D 1/18; C21D 1/84; C21D 6/002; C21D 6/005; C21D 6/008; C21D 8/10; C21D 9/085; C22C 38/001; C22C 38/002; C22C 38/02; C22C 38/04; C22C 38/06; C22C 38/32; C21D 2211/002

(57) ABSTRACT

The present invention provides a bainite seamless steel pipe and a manufacturing method therefor. In addition to Fe and inevitable impurities, the bainite seamless steel pipe further comprises the following chemical elements in percentage by mass: C: 0.16-0.18%, Si: 0.56-1%, Mn: 1.8-2.05%, Cr: 0.85-1.25%, Al: 0.015-0.04%, B: 0.001-0.005%, 0<N≤0.006%, wherein Al/N≥3. The bainite seamless steel pipe of the present invention can obtain good strength-toughness matching in a rolled state or a single tempered state without the need for quenching and tempering heat treatment.

### TECHNICAL FIELD

The present invention relates to a steel pipe and a manufacturing method therefor, particularly to a bainite seamless steel pipe and a manufacturing method therefor.

### BACKGROUND ART

In recent years, in order to meet the market demands, more and more seamless steel pipe products have been applied in various trades and industries and play a very important role.

In the prior art, in order to prepare a seamless steel pipe product having a yield strength of 80 ksi and a certain toughness, quenching and tempering heat treatment of the steel pipe is required.

However, this quenching and tempering heat treatment process not only consumes high energy, but also has a series of problems such as severe surface oxidation, and the steel pipe is prone to dimensional deterioration, cracking, and straightness deterioration during the quenching and tempering process. It is not in line with the current high-quality green development direction.

Therefore, in order to solve the problem in the prior art that the seamless steel pipe having 80 Ksi steel grade is required to be subjected to quenching and tempering heat treatment to obtain the strength-toughness matching, the present invention is expected to develop and obtain a new bainite seamless steel pipe product.

### SUMMARY OF THE INVENTION

One of the purposes of the present invention is to provide a bainite seamless steel pipe. The bainite seamless steel pipe can obtain good strength-toughness matching in a rolled state or a single tempered state by using reasonable chemical composition and process designs without the need for quenching and tempering heat treatment. The bainite seamless steel pipe is low in alloy cost and has good economy.

In order to achieve the above purpose, in one aspect, the present invention provides a bainite seamless steel pipe, wherein in addition to Fe and inevitable impurities, the bainite seamless steel pipe further comprises the following chemical elements in percentage by mass:
C: 0.16-0.18%, Si: 0.56-1%, Mn: 1.8-2.05%, Cr: 0.85-1.25%, Al: 0.015-0.04%, B: 0.001-0.005%, 0<N≤0.006%, wherein Al/N≥3.

Preferably, the present invention provides a bainite seamless steel pipe comprising the following chemical elements in percentage by mass:
C: 0.16-0.18%, Si: 0.56-1%, Mn: 1.8-2.05%, Cr: 0.85-1.25%, Al: 0.015-0.04%, B: 0.001-0.005%, 0<N≤0.006%, the balance being Fe and inevitable impurities, wherein Al/N≥3.

In the chemical composition design, the bainite seamless steel pipe according to the present invention uses air cooling high-hardenability composition design that can obtain the stable granular bainite structure in a wide range of a cooling speed, which is conducive to the stability of the structure and property of a thick-wall steel pipe.

In addition, the bainite seamless steel pipe according to the present invention does not comprise noble metals and microalloying elements such as Mo, Ni, Nb, V, Ti, and uses conventional elements such as Mn, Cr, and B, which has good economy and is low in alloy cost.

In the bainite seamless steel pipe according to the present invention, the design principle of each chemical element is described as follows.

C: The element C is an important element that ensures the strength of a steel. The addition of the element C can stabilize the bainite structure and improve the air cooling hardenability. Further, C also causes that the Continuous Cooling Transformation (CCT) curve is shifted to the right. By adding an appropriate amount of the element C in steel, it can be ensured that the steel can obtain the bainite structure at a low cooling rate. When the content of the element C in the steel is too low, the bainite structure may be unstable, and the strength and toughness of the steel may become worse; When the content of the element C in the steel is too high, the amount of martensite-austenite island may be increased, and the toughness of the steel may become worse. Therefore, in the bainite seamless steel pipe according to the present invention, the mass percentage of the element C is controlled to be 0.16-0.18%.

Si: The element Si is both a ferrite forming element and a deoxidizing element. The element Si can improve the purity of molten steel while inhibiting the precipitation of carbides. Adding an appropriate amount of the element Si in steel can not only ensure solid solution strengthening of the element C, but also decrease the amount of the martensite-austenite island and refine the structure of the martensite-austenite island, so that the strength-toughness matching of the steel is improved. When the content of Si in the steel is too low, it does not have the corresponding effect; When the content of Si in the steel exceeds 1%, there is no improvement on the structure. Therefore, in the bainite seamless steel pipe according to the present invention, the mass percentage of the element Si is controlled to be 0.56-1%, preferably 0.66-0.85%, still more preferably 0.75-0.85%.

Mn: Mn is an important element that improves the air cooling hardenability. Compared with the elements such as Mo, Cr and W, Mn is cheaper and more readily available. Compared with other elements, Mn can more significantly reduce the transformation point of bainite structure, so that the structure is effectively refined, and the strength and toughness of steel are improved. When the content of the element Mn in the steel is lower than 1.8%, an upper bainite structure is formed due to the decrease in hardenability, which will lead to poor toughness; When the content of the element Mn in the steel is higher than 2.05%, severe segregation of Mn will be caused, and the amount and size of the martensite-austenite island will be increased, so that that the toughness of the steelbecome worse. Therefore, in the bainite seamless steel pipe according to the present invention, the mass percentage content of the element Mn is controlled to be 1.8-2.05%, preferably 1.85-2%.

Cr: Cr is an important element that improves the air cooling hardenability. The combination of Cr with the elements Mn and B can ensure the formation of a stable air-cooled bainite structure under the conditions of 2-5° C./s. Further, Cr has a certain solid solution strengthening effect. While increasing the strength of the steel, it can also improve the corrosion resistance of the material, and thus improve the applicable working conditions of the steel pipe. When the content of Cr in the steel is too low, it is not possible to guarantee the formation of a stable bainite structure. When the content of Cr in the steel is too high, it will lead to the waste of alloy. Therefore, in the bainite seamless steel pipe according to the present invention, the mass percentage of the element Cr is controlled to be 0.85-1.25%, preferably 0.9-1.1%.

Al: Al is a good deoxidizing element, which can take an effect of deoxidization. However, adding Al in excess is prone to causing alumina inclusions. Therefore, it is necessary to increase the proportion of acid soluble aluminum in total aluminum as much as possible, and to feed an appropriate amount of Al wire after vacuum degassing. Therefore, in the bainite seamless steel pipe according to the present invention, the mass percentage of the element Al is controlled to be 0.015-0.04%.

B: The element B can increase the hardenability of the steel. Composite addition of the elements B and Mn can further improve the air cooling hardenability of the steel, and ensure the formation of a stable granular bainite structure. At the same time, the element B can further strengthen grain boundaries, inhibit the formation of martensite-austenite island, and improve the strength-toughness matching of the steel. When the content of the element B in the steel is smaller than 0.0015%, its effect is not obvious. When the content of the element B in the steel is too high, it is difficult to accurately control the steelmaking. Therefore, in order to exert the beneficial effects of element B, in the bainite seamless steel pipe according to the present invention, the mass percentage of the element B is controlled to be 0.001-0.005%, preferably 0.002-0.0045%.

N: The element N can form carbonitrides with Al and play a strengthening role to a certain extent. However, when the content of the element N is too high, it will lead to the reduction of impact toughness. Therefore, in the bainite seamless steel pipe according to the present invention, the mass percentage of the element N is controlled to be 0<N≤0.006%, preferably 0.004%≤N≤0.006%.

In the present invention, it is necessary to further control the mass percentages of the elements Al and N to satisfy the following formula: Al/N≥3, preferably Al/N≥3.33. The purpose of controlling the mass percentages of the elements Al and N to satisfy this relation formula is to ensure the content of acid soluble aluminum and that the acid-soluble aluminum is fully combined with the element N, thereby preventing N from being combined with B to form a brittle low-melting-point phase, so that an improvement effect of the element B on the hardenability of the steel is ensured, and the embrittlement of grain boundaries is prevented.

In the present invention, the element Ti is not added in the steel, and the Ti element is not used for N removal, thereby avoiding the problem that the element Ti forms coarse carbides, which compound with inclusions, resulting in deterioration of impact toughness.

Preferably, in the bainite seamless steel pipe according to the present invention, the inevitable impurities include P and S; wherein S≤0.01%, P≤0.005%.

In the bainite seamless steel pipe according to the present invention, the elements P and S are both impurity elements in the seamless steel pipe. If technical conditions permit, in order to obtain a seamless steel pipe having better property and quality, the content of impurity elements in the seamless steel pipe should be reduced as much as possible. When the content of the impurity element P is too high, P will cause segregation and embrittlement of the grain boundaries, thereby seriously deteriorating the toughness of the steel. Moreover, when the content of the impurity element S is too high, it will lead to an increase in the content of inclusions in the steel, which is unconducive to the low-temperature toughness of the steel. Therefore, in the bainite seamless steel pipe according to the present invention, the mass percentage of the element S is controlled to be S≤0.01%, and the mass percentage of the element P is controlled to be P≤0.005%.

Preferably, the bainite seamless steel pipe of the present invention the following performances in a rolled state: a yield strength of 552-758 MPa (preferably 650-758 MPa), a tensile strength of ≥980 MPa (preferably ≥1010 MPa), a longitudinal impact toughness of ≥40 J (preferably ≥60 J, further preferably ≥65 J), a yield ratio of 0.6-0.75, an elongation of 12-15%, a local residual stress of ≤200 MPa (preferably ≤190 MPa, more preferably ≤120 MPa) within a range of 1-2 mm in a wall thickness direction of its outer wall, an overall residual stress of ≤100 MPa (preferably ≤90 MPa, more preferably ≤50 MPa) throughout its pipe body.

Preferably, the bainite seamless steel pipe of the present invention after being tempered at a temperature of 200-350° C. has the following performances in a tempered state: a yield strength of 650-860 MPa, a tensile strength of ≥980 MPa (preferably ≥1050 MPa), a longitudinal impact toughness of ≥60 J (preferably ≥65 J), a yield ratio of 0.7-0.83.

Preferably, the bainite seamless steel pipe of the present invention after being tempered at a temperature of 400-460° C. has the following performances in a tempered state: a yield strength of 650-860 MPa, a tensile strength of ≥980 MPa.

Herein, “performance(s) in a rolled state” refers to the performance(s) that the bainite seamless steel pipe of the present invention exhibits after three-stage air cooling and without tempering; “performance(s) in a tempered state” refers to the performance(s) that the bainite seamless steel pipe of the present invention exhibits after further tempering after three-stage air cooling.

In another aspect, it is also an object of the present invention to provide a method for manufacturing the above mentioned bainite seamless steel pipe comprising the following steps:
(1) smelting molten steel and performing continuous casting to obtain a steel billet;
(2) performing perforation, continuous rolling and sizing of the steel billet to obtain a steel pipe;
(3) air cooling the steel pipe after sizing in three-stages: cooling is performed in a range of 500-850° C. in the first stage in a controlled cooling rate of 2-5° C./s; after cooling to 500° C., a cooling rate in the second stage is controlled to be 5-15° C./s (preferably 8.5-15° C./s); after cooling to 300° C., natural air cooling is performed to obtain the bainite seamless steel pipe.

The method of the present invention does not employ a quenching and tempering heat treatment process. This method has a short process and low energy consumption, and avoids a series of problems such as size deterioration and surface oxidation caused by quenching and tempering. The bainite seamless steel pipe product produced by this method can obtain good strength-toughness matching in the rolled state or the single tempered state, and has good application prospect. In the method of the present invention, the inventor performed three-stage air cooling control on the sized steel pipe. Through the optimization design for three-stage air cooling process, the problem that the transformation of the outer wall surface is not synchronized with that of the center and inner wall of the bainite seamless steel pipe is prevented effectively, and thus the problem of longitudinal cracking of the outer surface caused by that the local residual stress is too large within the range of 1-2 mm in the wall thickness direction of the outer wall of the pipe body is avoided.

In addition, the three-stage cooling control process of the present invention can also control the structure transformation within a stable bainite phase transformation range, so as to ensure the overall structure and strength-toughness matching of the bainite seamless steel pipe, while preventing the problem that the macroscopic residual stress of the pipe body is large, which ensures the performances of the bainite seamless steel pipe during the subsequent use.

In step (3) of the present invention, the cooling rate of the first stage is controlled to be 2-5° C./s. Within this cooling rate range, it can be guaranteed that the ferrite phase transformation does not occur in advance, and that the supercooled austenite undergo stable bainite phase transformation at 500° C. or less. At the same time, by the use of this cooling rate, it can be prevented that the difference between the cooling rate within the range of 1-2 mm in the wall thickness direction of the outer wall of the bainite seamless steel pipe and the cooling rate at the other positions of the pipe body is too large, thereby avoiding the problem of asynchronous phase transformation and preventing the residual stress within the range of 1-2 mm in the wall thickness direction of the outer wall of the bainite seamless steel pipe from being too large.

When the local residual stress is too large within the range of 1-2 mm in the wall thickness direction of the outer wall of the bainite seamless steel pipe, the defect tolerance of the outer surface of the steel pipe becomes poor, and the outer wall of the pipe body cracks at the position within the range of 1-2 mm in the wall thickness direction during use. Therefore, the process design of the present invention can reasonably control the local residual stress to be ≤200 MPa within the range of 1-2 mm in the wall thickness direction of the outer wall of the steel pipe.

The cooling rate in the second stage is controlled to be 5-15° C./s. The use of the cooling rate can improve the stability of supercooled austenite, ensure that the bainite undergoes a structure transformation at a lower temperature, form stable fine bainite structure, reduce the size of the martensite-austenite island, and thus ensure the strength-toughness matching. At the same time, the use of the cooling rate can effectively control the mutual cancellation of thermal stress and phase transformation stress in a cooling phase transformation process, thereby reducing the final residual stress and improving the deformation resistance of the product.

In the third stage of cooling, after cooling to 300° C., the natural air cooling is performed. This is because, after cooling to 300° C., the bainite phase transformation has been completed, and self-tempering can be performed by using residual heat to further enhance the strength and toughness, while reducing the overall residual stress level of the pipe body of the bainite seamless steel pipe.

In the present invention, by controlling the three-stage air cooling process, it can be ensured that the local residual stress is ≤200 MPa within the range of 1-2 mm in the wall thickness direction of the outer wall of the bainite seamless steel pipe, and the overall residual is ≤100 MPa stress throughout the pipe body. It not only improves the defect tolerance of the outer surface of the steel pipe, but also improves the resistance of the pipe body to crack propagation after the surface scratch occurs during subsequent use, and at the same time improves the overall performances and service life of the pipe body during use.

Preferably, in step (1) of the method according to the present invention, scrap steel and blast furnace molten iron are used to make the molten steel, wherein the blast furnace molten iron is used at a mass percentage of 50-60%.

Preferably, in step (1) of the method according to the present invention, the molten steel can be smelted through the electric furnace, and after secondary refining, vacuum degassing and argon stirring, Ca treatment is performed to denature the inclusions, thereby reducing the content of the elements O and H.

Preferably, in step (1) of the method according to the present invention, in the continuous casting, the alloy is cast into a round billet, the superheat of the molten steel is controlled to be lower than 30° C. during the continuous casting, the drawing speed during the continuous casting is controlled to be 1.8-2.2 m/min, which can reduce component segregation.

Preferably, in the method according to the present invention, in step (2), the obtained round billet is cooled and then heated in an annular heating furnace, a heating temperature of 1240-1300° C., a heating time is 3-6 h.

Preferably, in step (2) of the method according to the present invention, perforation is performed after heating at temperature of 1180-1240° C.

Preferably, in step (2) of the method according to the present invention, continuous rolling is performed after perforation at a temperature of 1000-1100° C.; after continuous rolling, the pipe body is naturally cooled, and then is heated to 950-980° C. in a reheating furnace, and then taken out of the furnace for sizing at a temperature of 850-950° C.

Preferably, the method according to the present invention further comprises step (4): the bainite seamless steel pipe obtained in step (3) is subjected to a tempering process. The bainite seamless steel pipe obtained after the tempering treatment has good strength-toughness matching.

Preferably, in step (4) of the method according to the present invention, the tempering temperature is 200° C.-350° C. or 400° C.-460° C.

Compared with the prior art, the bainite seamless steel pipe and the manufacturing method therefor according to the present invention have the following advantages and beneficial effects:

The present invention provides a new bainite seamless steel pipe product, which can obtain good strength-toughness matching in the rolled state or the single tempered state through reasonable chemical composition and process designs without the need for quenching and tempering heat treatment. This product has a short process flow and low energy consumption, and avoids a series of problems such as size deterioration and surface oxidation caused by quenching and tempering.

When designing the chemical composition, the inventors used air cooling high-hardenability composition design that can obtain the stable granular bainite structure in a wide range of the cooling speed, which is conducive to the stability of the structure and property of the thick-wall steel pipe. In addition, in the design of chemical element composition, the seamless steel pipe according to the present invention does not comprise noble metals and microalloying elements such as Mo, Ni, Nb, V, Ti, and adopts the reasonable design of the conventional elements such as Mn, Cr, and B, which has good economy and is low in alloy cost.

The present invention also designs the parameter control of different air cooling stages after rolling in the manufacturing process. Through the three-stage air cooling control of the steel pipe after sizing, the problem that the transformation of the outer wall surface is not synchronized with that of the center and inner wall of the steel pipe is prevented effectively, and thus the problem of longitudinal cracking of the outer surface caused by that the local residual stress is too large within the range of 1-2 mm in the wall thickness direction of the outer wall of the pipe body is avoided. In addition, this three-stage cooling control process can also control the structure transformation in the stable bainite phase transformation range, so as to ensure the overall structure and strength-toughness matching of the bainite seamless steel pipe, while preventing the problem that the macroscopic residual stress of the pipe body is large, which ensures the performances during the subsequent use.

The bainite seamless steel pipe product provided by the present invention has good strength-toughness matching in the rolled state and the single tempered state. In the rolled state, the yield strength is 552-758 MPa, the tensile strength is ≥980 MPa, the longitudinal impact toughness is ≥40 J, the yield ratio is 0.6-0.75, the local residual stress is ≤200 MPa within the range of 1-2 mm in the wall thickness direction of the outer wall of the bainite seamless steel pipe, the overall residual stress is ≤100 MPa throughout the pipe body. After the bainite seamless steel pipe in the rolled state is subjected to singe tempering treatment at the temperature of 200-350° C., the yield strength is increased to 650-860 MPa, the tensile strength is ≥980 MPa, the longitudinal impact toughness is ≥60 J, the yield ratio is 0.7-0.83. In this case, the bainite seamless steel pipe has the best strength-toughness matching.

In addition, after the bainite seamless steel pipe in the rolled state is subjected to singe tempering treatment at the temperature of 400-460° C., the strength of the bainite seamless steel pipe can meet the requirement, but the bainite seamless steel pipe has obvious temper brittleness. In this case, the longitudinal impact toughness is ≤20 J.

### DETAILED DESCRIPTION OF THE EMBODIMENTS

Hereinafter, the bainite seamless steel pipe and the manufacturing method therefor according to the present invention will be further explained and illustrated below with reference to specific Examples. However, the explanations and illustrations do not unduly limit the technical solutions of the present invention.

### Examples 1-6 and Comparative Examples 1-9

The bainite seamless steel pipes in Examples 1-6 of the present invention and the seamless steel pipes in Comparative Examples 1-9 are manufactured by the following steps:
(1) according to the chemical composition shown in Table 1, smelting and continuous casting: scrap steel and blast furnace molten iron are used to make the molten steel, wherein the blast furnace molten iron is used at a mass percentage of 50-60% %; the molten steel is smelted through the electric furnace, and after secondary refining, vacuum degassing and argon stirring, Ca treatment is performed to denature the inclusions, thereby reducing the content of the elements O and H. Then in the continuous casting, the superheat of the molten steel is controlled to be lower than 30° C., the drawing speed during the continuous casting is controlled to be 1.8-2.2 m/min.
(2) perforation, continuous rolling and sizing: after the obtained steel billet is cooled, the steel billet is heated in an annular heating furnace, the temperature in the annular heating furnace is controlled to be 1240-1300° C., the heating time is controlled to be 3-6 h. After heating, perforation is performed at a temperature of 1180-1240° C. After perforation, continuous rolling is performed at a temperature of 1000-1100° C. After continuous rolling, the pipe body is naturally cooled for 30 seconds, then placed in a reheating furnace to be heated to 950-980° C., and then taken out of the furnace for sizing at a temperature of 850-950° C.
(3) air cooling the steel pipe after sizing in three-stage: cooling is performed in a range of 500-850° C. in the first stage in a controlled cooling rate of 2-5° C./s; after cooling to 500° C., a cooling rate in the second stage is controlled to be 5-15° C./s; after cooling to 300° C., natural air cooling is performed in the third stage.

The bainite seamless steel pipes of Examples 1-6 of the present invention are all manufactured by the method comprising the above-mentioned steps, and their chemical element composition and related process designs meet the design specification requirements of the present invention. The seamless steel pipes of Comparative Examples 1-9 are manufactured by basically the same method as Examples 1-6 of the present invention, except that at least one of the parameters in the chemical compositions and/or processes of the seamless steel pipes of Comparative Examples 1-9 does not meet the requirements of the present invention.

The mass percentages of each chemical element of the bainite seamless steel pipes in Examples 1-6 and the seamless steel pipes in Comparative Examples 1-9 are listed in Table 1.

TABLE 1
(The balance is Fe and other inevitable impurities except for P and S)

| | Chemical elements | | | | | | | | | |
|---|---|---|---|---|---|---|---|---|---|---|
| | C | Si | Mn | S | P | Cr | Al | N | B | |
| Number | (wt %) | (wt %) | (wt %) | (wt %) | (wt %) | (wt %) | (wt %) | (wt %) | (wt %) | Al/N |
| Example 1 | 0.16 | 0.56 | 1.82 | 0.008 | 0.001 | 0.85 | 0.015 | 0.004 | 0.002 | 3.75 |
| Example 2 | 0.17 | 0.66 | 1.85 | 0.007 | 0.002 | 0.9 | 0.025 | 0.006 | 0.0045 | 4.17 |
| Example 3 | 0.18 | 0.75 | 1.93 | 0.006 | 0.003 | 0.95 | 0.038 | 0.005 | 0.003 | 7.60 |
| Example 4 | 0.16 | 0.85 | 1.95 | 0.005 | 0.004 | 1 | 0.02 | 0.006 | 0.001 | 3.33 |
| Example 5 | 0.17 | 0.99 | 2.04 | 0.005 | 0.0035 | 1.24 | 0.03 | 0.005 | 0.0035 | 6.00 |
| Example 6 | 0.16 | 0.85 | 2 | 0.005 | 0.003 | 1.1 | 0.032 | 0.005 | 0.0025 | 6.40 |
| Comparative | 0.14 | 0.83 | 2.03 | 0.01 | 0.0025 | 0.95 | 0.02 | 0.004 | 0.0025 | 5.00 |
| Example 1 | | | | | | | | | | |
| Comparative | 0.17 | 0.94 | 1.7 | 0.006 | 0.001 | 0.85 | 0.025 | 0.0025 | 0.002 | 10.00 |
| Example 2 | | | | | | | | | | |
| Comparative | 0.16 | 0.75 | 1.95 | 0.004 | 0.002 | 0.73 | 0.03 | 0.005 | 0.0025 | 6.00 |
| Example 3 | | | | | | | | | | |
| Comparative | 0.2 | 0.68 | 1.93 | 0.005 | 0.002 | 0.96 | 0.02 | 0.004 | 0.002 | 5.00 |
| Example 4 | | | | | | | | | | |
| Comparative | 0.17 | 0.72 | 1.91 | 0.005 | 0.001 | 1.06 | 0.015 | 0.006 | 0.001 | 2.50 |
| Example 5 | | | | | | | | | | |
| Comparative | 0.17 | 0.76 | 1.85 | 0.002 | 0.002 | 1.1 | 0.015 | 0.005 | 0.0015 | 3.00 |
| Example 6 | | | | | | | | | | |
| Comparative | 0.17 | 0.79 | 1.90 | 0.002 | 0.002 | 1.2 | 0.015 | 0.005 | 0.0015 | 3.00 |
| Example 7 | | | | | | | | | | |
| Comparative | 0.18 | 0.72 | 1.9 | 0.002 | 0.001 | 1.1 | 0.015 | 0.005 | 0.0015 | 3.00 |
| Example 8 | | | | | | | | | | |
| Comparative | 0.16 | 0.75 | 1.95 | 0.003 | 0.002 | 0.95 | 0.015 | 0.005 | 0.0025 | 3.00 |
| Example 9 | | | | | | | | | | |

The specific process parameters in the above process steps of the methods for manufacturing the bainite seamless steel pipes of Examples 1-6 and the seamless steel pipes of Comparative Examples 1-9 are listed in Table 2-1 and Table 2-2.

TABLE 2-1

| | Step (1) | | | | | | | | |
|---|---|---|---|---|---|---|---|---|---|
| | Mass | | | | | | | | |
| | percentage | | | | | | | | |
| | of blast | | drawing | Step (2) | | | | | |
| | furnace | Super | speed of | Temperature | | | Continuous | | |
| | molten | heat | continuous | in annular | Heating | Perforation | rolling | Reheating | Sizing |
| | iron | degree | casting | furnace | time | temperature | temperature | temperature | temperature(° |
| Number | (%) | (° C.) | (m/min) | (° C.) | (h) | (° C.) | (° C.) | (° C.) | C.) |
| Example 1 | 50 | 25 | 2.1 | 1250 | 4 | 1190 | 1005 | 955 | 860 |
| Example 2 | 55 | 15 | 2 | 1260 | 3.8 | 1210 | 1010 | 950 | 870 |
| Example 3 | 52 | 25 | 1.9 | 1250 | 5 | 1200 | 1020 | 960 | 945 |
| Example 4 | 54 | 28 | 2 | 1260 | 5.5 | 1190 | 1030 | 975 | 920 |
| Example 5 | 58 | 15 | 2.2 | 1270 | 5.8 | 1220 | 1060 | 980 | 910 |
| Example 6 | 60 | 25 | 2 | 1290 | 5.7 | 1240 | 1095 | 965 | 930 |
| Comparative | 53 | 20 | 2 | 1260 | 5.3 | 1190 | 1060 | 960 | 900 |
| Example 1 | | | | | | | | | |
| Comparative | 51 | 18 | 2.1 | 1250 | 4.5 | 1220 | 1050 | 955 | 890 |
| Example 2 | | | | | | | | | |
| Comparative | 50 | 20 | 1.8 | 1260 | 6 | 1230 | 1060 | 965 | 880 |
| Example 3 | | | | | | | | | |
| Comparative | 55 | 25 | 1.9 | 1260 | 5.5 | 1210 | 1030 | 970 | 870 |
| Example 4 | | | | | | | | | |
| Comparative | 57 | 21 | 2 | 1270 | 4.5 | 1230 | 1030 | 975 | 910 |
| Example 5 | | | | | | | | | |
| Comparative | 58 | 18 | 2.1 | 1250 | 5.5 | 1220 | 1020 | 964 | 930 |
| Example 6 | | | | | | | | | |
| Comparative | 59 | 19 | 2 | 1260 | 5 | 1210 | 1030 | 960 | 910 |
| Example 7 | | | | | | | | | |
| Comparative | 54 | 18 | 2 | 1265 | 4 | 1200 | 1010 | 970 | 880 |
| Example 8 | | | | | | | | | |
| Comparative | 52 | 17 | 2 | 1255 | 5.2 | 1210 | 1020 | 975 | 920 |
| Example 9 | | | | | | | | | |

TABLE 2-2

| | Step (3) | | | | | |
|---|---|---|---|---|---|---|
| | Initial | | Initial | | Initial | |
| | cooling | | cooling | Cooling | cooling | |
| | temperature | Cooling | temperature | rate in | temperature | Cooling |
| | in first | rate in | in second | second | in third | process |
| | stage | first stage | stage | stage | stage | in third |
| Number | (° C.) | (° C./s) | (° C.) | (° C./s) | (° C.) | stage |
| Example 1 | 850 | 2.5 | 500 | 5.5 | 300 | Natural |
| | | | | | | cooling |
| Example 2 | 850 | 5 | 500 | 14.5 | 300 | Natural |
| | | | | | | cooling |
| Example 3 | 850 | 3 | 500 | 8.5 | 300 | Natural |
| | | | | | | cooling |
| Example 4 | 850 | 4 | 500 | 12.5 | 300 | Natural |
| | | | | | | cooling |
| Example 5 | 850 | 4.5 | 500 | 10.5 | 300 | Natural |
| | | | | | | cooling |
| Example 6 | 850 | 3 | 500 | 13.5 | 300 | Natural |
| | | | | | | cooling |
| Comparative | 850 | 4.9 | 500 | 9 | 300 | Natural |
| Example 1 | | | | | | cooling |
| Comparative | 850 | 2.1 | 500 | 12.5 | 300 | Natural |
| Example 2 | | | | | | cooling |
| Comparative | 850 | 3 | 500 | 14 | 300 | Natural |
| Example 3 | | | | | | cooling |
| Comparative | 850 | 4 | 500 | 14.8 | 300 | Natural |
| Example 4 | | | | | | cooling |
| Comparative | 850 | 3 | 500 | 6 | 300 | Natural |
| Example 5 | | | | | | cooling |
| Comparative | 850 | 1 | 500 | 8 | 300 | Natural |
| Example 6 | | | | | | cooling |
| Comparative | 850 | 7 | 500 | 7 | 300 | Natural |
| Example 7 | | | | | | cooling |
| Comparative | 850 | 3 | 500 | 4 | 300 | Natural |
| Example 8 | | | | | | cooling |
| Comparative | 850 | 4 | 500 | 18 | 300 | Natural |
| Example 9 | | | | | | cooling |

It is not difficult to see from the above Table 1, Table 2-1 and Table 2-2 that in the present invention, the content of the element C in Comparative Example 1 is lower than the design requirement; the content of the element Mn in Comparative Example 2 is lower than the design requirement; the content of the element Cr in Comparative Example 3 is lower than the design requirement; the content of the element C in Comparative Example 4 is higher than the design requirement; the Al/N ratio in Comparative Example 5 is less than 3; the cooling rate in first stage after sizing of the seamless steel pipe in Comparative Example 6 is low than the design requirement; the cooling rate in first stage after sizing of the seamless steel pipe in Comparative Example 7 is higher than the design requirement; the cooling rate in second stage after sizing of the seamless steel pipe in Comparative Example 8 is lower than the design requirement; the cooling rate in second stage after sizing of the seamless steel pipe in Comparative Example 9 is higher than the design requirement.

The obtained bainite seamless steel pipes in the rolled state of Examples 1-6 and the seamless steel pipes of Comparative Examples 1-9 are sampled respectively, and various performance tests were conducted. The test results obtained are listed in Table 3.

The methods of the relevant performance tests are described as follows:
(1) Tensile test: According to GB/T 228.1-Metallic materials-Tensile testing, the value of the yield strength, the tensile strength, the yield ratio, and the elongation at room temperature of the bainite seamless steel pipes of each Example and the seamless steel pipes of each Comparative Example are measured. Wherein, yield ratio=yield strength/tensile strength.
(2) Impact test: According to GB/T 229-Metallic materials-Charpy pendulum impact test, the longitudinal impact toughness at room temperature of the bainite seamless steel pipes of each Example and the seamless steel pipes of each Comparative Example are measured.
(3) Residual stress test: According to the standard ISO/TR 10400, the residual stress of the bainite seamless steel pipes of each Example and the seamless steel pipes of each Comparative Example are measured to obtain the overall residual stress throughout the pipe body and the local residual stress within the range of 1-2 mm in the wall thickness direction of the outer wall of the seamless steel pipe.

The performance test results of the bainite seamless steel pipes of Examples 1-6 and the seamless steel pipes of Comparative Examples 1-9 are listed in Table 3.

TABLE 3

| | | | | | | Local residual | |
|---|---|---|---|---|---|---|---|
| | | | | | | stress within | |
| | | | | | | the range of | |
| | | | | | | 1-2 mm in the | |
| | | | | | Longitudinal | wall thickness | Overall |
| | | | | | impact | direction of | residual |
| | | | | | toughness | outer wall | stress |
| | Yield | Tensile | | | at room | of seamless | throughout |
| | strength | strength | Yield | Elongation | temperature | steel pipe | pipe body |
| Number | (MPa) | (MPa) | ratio | (%) | (J) | (MPa) | (MPa) |
| Example 1 | 745 | 1003 | 0.74 | 12 | 65 | 100 | 90 |
| Example 2 | 560 | 980 | 0.61 | 13 | 70 | 120 | 80 |
| Example 3 | 650 | 1020 | 0.64 | 14 | 88 | 110 | 20 |
| Example 4 | 680 | 1010 | 0.67 | 15 | 95 | 80 | 50 |
| Example 5 | 690 | 1030 | 0.67 | 13 | 85 | 190 | 30 |
| Example 6 | 720 | 1020 | 0.71 | 12 | 90 | 90 | 50 |
| Comparative | 530 | 860 | 0.62 | 16 | 20 | 150 | 60 |
| Example 1 | | | | | | | |
| Comparative | 450 | 768 | 0.59 | 14 | 15 | 100 | 70 |
| Example 2 | | | | | | | |
| Comparative | 480 | 801 | 0.60 | 15 | 25 | 20 | 65 |
| Example 3 | | | | | | | |
| Comparative | 820 | 1150 | 0.71 | 13 | 12 | 60 | 55 |
| Example 4 | | | | | | | |
| Comparative | 470 | 756 | 0.62 | 14 | 16 | 50 | 15 |
| Example 5 | | | | | | | |
| Comparative | 520 | 860 | 0.60 | 13 | 45 | 30 | 80 |
| Example 6 | | | | | | | |
| Comparative | 620 | 980 | 0.63 | 15 | 80 | 260 | 75 |
| Example 7 | | | | | | | |
| Comparative | 490 | 870 | 0.56 | 12 | 15 | 140 | 160 |
| Example 8 | | | | | | | |
| Comparative | 850 | 1150 | 0.74 | 14 | 60 | 120 | 210 |
| Example 9 | | | | | | | |

It can be seen from Table 3 that compared with the seamless steel pipes of Comparative Examples 1-9, the comprehensive performances of the bainite seamless steel pipes in Examples 1-6 of the present invention are significantly better.

It can be seen from Table 3 that after steps (1)-(3) of the manufacturing method of the present invention are completed, the obtained bainite seamless steel pipes in the rolled state of Examples 1-6 have the following excellent mechanical performances: the strength-toughness matching is good, the yield strength is 560-745 MPa, the tensile strength is 980-1030 MPa, the yield ratio is 0.61-0.74, the elongation is 12-15%, and the longitudinal impact toughness at room temperature is 65-95 J.

It can be seen from Table 3 that the bainite seamless steel pipes in the rolled state of Examples 1-6 have the following performances: the overall residual stress is 20-90 MPa throughout the pipe body, and the local residual stress is 80-120 MPa in the range of 1-2 mm in the wall thickness direction of the outer wall. Correspondingly, during subsequent use, the bainite seamless steel pipes in the rolled state of Examples 1-6 have excellent resistance to the crack propagation after surface is scratched.

After the above performance test and analysis are completed, the bainite seamless steel pipes in the rolled state of Examples 1 to 6 are tempered. The obtained bainite seamless steel pipes in the tempered state also have good strength-toughness matching. In the present invention, after the bainite seamless steel pipe in the rolled state is tempered at the temperature of 200-350° C., the yield strength is increased by 50-100 MPa, the tensile strength is slightly increased, the yield ratio reaches 0.73-0.83, the longitudinal impact toughness is ≥60 J, and it has the best strength-toughness matching. However, after the bainite seamless steel pipe in the rolled state is tempered at the temperature of 400-460° C., the strength can meet the requirement, but the bainite seamless steel pipe has obvious temper brittleness, and the longitudinal impact toughness is ≤20 J.

Taking the bainite seamless steel pipe in the rolled state of Example 1 as an example, the bainite seamless steel pipe prepared through the above steps (1)-(3) is further subjected to step (4): tempering treatment.

The bainite seamless steel pipe in the rolled state of Example 1 is sampled and divided into 5 groups. These 5 groups are tempered at different tempering temperatures (200° C., 300° C., 350° C., 400° C., 460° C.).

The five groups of the bainite seamless steel pipes that have completed the tempering treatment are sampled respectively, and tensile test and impact test are conducted on the five groups of samples respectively to obtain the yield strength, the tensile strength, the yield ratio, the longitudinal impact toughness, and the elongation of the bainite seamless steel pipe in the tempered state of each group. The test results are listed in Table 4 below. The relevant test methods of the tensile test and impact test are the same as in Table 3 above.

The mechanical performances of the bainite seamless steel pipe in the rolled state of Example 1 and the bainite seamless steel pipes in the tempered state after the bainite seamless steel pipe in the rolled state of Example 1 is subjected to tempering treatment at five different tempering temperatures are listed in Table 4.

TABLE 4

| | | | | | Longitudinal |
|---|---|---|---|---|---|
| | | | | | impact |
| | | | | | toughness at |
| | Yield | Tensile | | | room |
| | strength | strength | Yield | Elongation | temperature |
| Example 1 | (Mpa) | (Mpa) | ratio | (%) | (J) |
| In the | 745 | 1003 | 0.74 | 12 | 65 |
| rolled state | | | | | |
| Tempering | 845 | 1153 | 0.73 | 13 | 82 |
| at 200° C. | | | | | |
| Tempering | 835 | 1080 | 0.77 | 13 | 86 |
| at 300° C. | | | | | |
| Tempering | 825 | 1050 | 0.79 | 14 | 90 |
| at 350° C. | | | | | |
| Tempering | 815 | 980 | 0.83 | 12 | 19 |
| at 400° C. | | | | | |
| Tempering | 805 | 995 | 0.81 | 12 | 15 |
| at 460° C. | | | | | |

As shown in Table 4, taking the bainite seamless steel pipe in the rolled state of Example 1 as an example, after the bainite seamless steel pipe is tempered at the temperature of 200-350° C., the yield strength is greatly improved, the tensile strength is slightly improved, and the bainite seamless steel pipe has good strength-toughness matching. Specifically, the yield strength is 825-845 MPa, the tensile strength is 1050-1153 MPa, the yield ratio reaches 0.73-0.79, the elongation is 13-14%, the longitudinal impact toughness is 82-90 J, and the strength-toughness matching is best.

Taking the bainite seamless steel pipe in the rolled state of Example 1 as an example, after the bainite seamless steel pipe is tempered at the temperature of 400-460° C., the strength of the bainite seamless steel pipe can meet the requirement, but the bainite seamless steel pipe has obvious temper brittleness, and the longitudinal impact toughness is 15-19 J.

In summary, the bainite seamless steel pipe of the present invention can obtain good strength-toughness matching in the rolled state or the single tempered state through reasonable composition matching and process designs without the need for quenching and tempering heat treatment. The bainite seamless steel pipe has a short process flow and low energy consumption, and can effectively avoid a series of problems such as size deterioration and surface oxidation caused by quenching and tempering.

It needs to be noted that the combination of various technical features in this case is not limited to the combination described in the claims or the combination described in specific Examples of this case. All technical features described in the present case can be freely combined in any way, unless there is a contradiction between them.

It also needs to be noted that the Examples listed above are only the specific embodiments of the present invention. Obviously, the present invention is not limited to the above Examples, and similar variations or deformations made accordingly can be easily thought of or directly obtained from the content of the present invention by those skilled in the art, and all should fall within the protection scope of the present invention.

1. A bainite seamless steel pipe, wherein in addition to Fe and inevitable impurities, the bainite seamless steel pipe further comprises the following chemical elements in percentage by mass:
C: 0.16-0.18%, Si: 0.56-1%, Mn: 1.8-2.05%, Cr: 0.85-1.25%, Al: 0.015-0.04%, B: 0.001-0.005%, 0<N≤0.006%, wherein Al/N≥3.

2. The bainite seamless steel pipe according to claim 1, wherein the bainite seamless steel pipe comprises the following chemical elements in percentage by mass:
C: 0.16-0.18%, Si: 0.56-1%, Mn: 1.8-2.05%, Cr: 0.85-1.25%, Al: 0.015-0.04%, B: 0.001-0.005%, 0<N≤0.006%, the balance being Fe and inevitable impurities, wherein Al/N≥3.

3. The bainite seamless steel pipe according to claim 1, wherein the inevitable impurities include S and P; wherein S≤0.01%, P≤0.005%.

4. The bainite seamless steel pipe according to claim 1, wherein the bainite seamless steel pipe has the following performances in a rolled state: a yield strength of 552-758 MPa, a tensile strength of ≥980 MPa, a longitudinal impact toughness of ≥40 J, a yield ratio of 0.6-0.75, an elongation of 12-15%, a local residual stress of ≤200 MPa within a range of 1-2 mm in a wall thickness direction of its outer wall, an overall residual stress of ≤100 MPa throughout its pipe body.

5. The bainite seamless steel pipe according to claim 1, wherein the bainite seamless steel pipe after being tempered at a temperature of 200-350° C. has the following performances in a tempered state: a yield strength of 650-860 MPa, a tensile strength of ≥980 MPa, a longitudinal impact toughness of ≥60 J, a yield ratio of 0.7-0.83.

6. The bainite seamless steel pipe according to claim 1, wherein the bainite seamless steel pipe after being tempered at a temperature of 400-460° C. has the following performances in a tempered state: a yield strength of 650-860 MPa, a tensile strength of ≥980 MPa.

7. The bainite seamless steel pipe according to claim 1, wherein the bainite seamless steel pipe is free of Mo, Ni, Nb, V and/or Ti; and/or, the bainite seamless steel pipe satisfies one or more of the following: Si content is in a range of 0.66-0.85%, preferably 0.75-0.85%; Mn content is in a range of 1.85-2%; Cr content is in a range of 0.9-1.1%; B content is in a range of 0.002-0.0045%; N content is in a range of 0.004-0.006%.

8. The bainite seamless steel pipe according to claim 1, wherein the bainite seamless steel pipe has a bainite structure.

9. A method for manufacturing the bainite seamless steel pipe according to claim 1, wherein the method comprises the following steps:
(1) smelting molten steel and performing continuous casting to obtain a steel billet;
(2) performing perforation, continuous rolling and sizing of the steel billet to obtain a steel pipe;
(3) air cooling the steel pipe after sizing in three-stages: cooling is performed in a range of 500-850° C. in the first stage in a controlled cooling rate of 2-5° C./s; after cooling to 500° C., a cooling rate in the second stage is controlled to be 5-15° C./s, preferably 8.5-15° C./s; after cooling to 300° C., natural air cooling is performed to obtain the bainite seamless steel pipe.

10. The method according to claim 9, wherein the method satisfies one or more of the following:
a: in step (1), scrap steel and blast furnace molten iron are used to make the molten steel, wherein the blast furnace molten iron is used at a mass percentage of 50-60%; and/or, in the continuous casting, the molten steel has a superheat of lower than 30° C., and a drawing speed during the continuous casting is 1.8-2.2 m/min;
b: before step (2), the steel billet is cooled and then heated, a heating temperature is 1240-1300° C., a heating time is 3-6 h;
c: in step (2), the perforation is performed at a temperature of 1180-1240° C., the continuous rolling is performed at a temperature of 1000° C.-1100° C.;
d: in step (2), after the continuous rolling and before the sizing, the pipe body is naturally cooled and then heated to 950-980° C., and then taken out of the furnace for sizing at a temperature of 850-950° C.

11. The method according to claim 9, wherein the method further comprises step (4): tempering the bainite seamless steel pipe obtained in step (3) at a temperature of 200-350° C. or 400-460° C.

12. The bainite seamless steel pipe according to claim 2, wherein the inevitable impurities include S and P; wherein S≤0.01%, P≤0.005%.

13. The bainite seamless steel pipe according to claim 2, wherein the bainite seamless steel pipe has the following performances in a rolled state: a yield strength of 552-758 MPa, a tensile strength of ≥980 MPa, a longitudinal impact toughness of ≥40 J, a yield ratio of 0.6-0.75, an elongation of 12-15%, a local residual stress of ≤200 MPa within a range of 1-2 mm in a wall thickness direction of its outer wall, an overall residual stress of ≤100 MPa throughout its pipe body.

14. The bainite seamless steel pipe according to claim 2, wherein the bainite seamless steel pipe after being tempered at a temperature of 200-350° C. has the following performances in a tempered state: a yield strength of 650-860 MPa, a tensile strength of ≥980 MPa, a longitudinal impact toughness of ≥60 J, a yield ratio of 0.7-0.83.

15. The bainite seamless steel pipe according to claim 2, wherein the bainite seamless steel pipe after being tempered at a temperature of 400-460° C. has the following performances in a tempered state: a yield strength of 650-860 MPa, a tensile strength of ≥980 MPa.

16. The bainite seamless steel pipe according to claim 2, wherein the bainite seamless steel pipe is free of Mo, Ni, Nb, V and/or Ti; and/or, the bainite seamless steel pipe satisfies one or more of the following: Si content is in a range of 0.66-0.85%, preferably 0.75-0.85%; Mn content is in a range of 1.85-2%; Cr content is in a range of 0.9-1.1%; B content is in a range of 0.002-0.0045%; N content is in a range of 0.004-0.006%.

17. The bainite seamless steel pipe according to claim 2, wherein the bainite seamless steel pipe has a bainite structure.

18. The method according to claim 9, wherein the bainite seamless steel pipe comprises the following chemical elements in percentage by mass:
C: 0.16-0.18%, Si: 0.56-1%, Mn: 1.8-2.05%, Cr: 0.85-1.25%, Al: 0.015-0.04%, B: 0.001-0.005%, 0<N≤0.006%, the balance being Fe and inevitable impurities, wherein Al/N≥3.

19. The method according to claim 9, wherein the inevitable impurities include S and P; wherein S≤0.01%, P≤0.005%.

20. The method according to claim 9, wherein the bainite seamless steel pipe has the following performances in a rolled state: a yield strength of 552-758 MPa, a tensile strength of ≥980 MPa, a longitudinal impact toughness of ≥40 J, a yield ratio of 0.6-0.75, an elongation of 12-15%, a local residual stress of ≤200 MPa within a range of 1-2 mm in a wall thickness direction of its outer wall, an overall residual stress of ≤100 MPa throughout its pipe body.
